(19) United States
(12) Patent Application Publication
(10) Pub. No.: US 2020/0386313 A1
(43) Pub. Date: Dec. 10, 2020

(54) SEALING GASKET

(71) Applicants: Hyundai Motor Company, Seoul (KR); Kia Motors Corporation, Seoul (KR)

(72) Inventors: Joong Hyun Hwang, Suwon (KR); Seok Jun Yoon, Anyang (KR); Won Hyuk Koh, Seoul (KR)

(21) Appl. No.: 16/686,389

(22) Filed: Nov. 18, 2019

(30) Foreign Application Priority Data
Jun. 7, 2019 (KR) 10-2019-0067113

(51) Int. Cl. F16J 15/10; F16J 15/02

(52) U.S. Cl. CPC F16J 15/104; F16J 15/022

(57) ABSTRACT

A sealing gasket provides a sealing gasket that copes with a step between the joint surfaces of a T-joint part of components to be assembled to prevent a sealing quality problem such as oil leakage or water leakage between the components, and mitigates the precision machining degree of the T-joint part and the joint surfaces. The sealing gasket includes a first gasket part interposed between a first component and a third component and a second gasket part interposed between a second component and the third component and separated and spaced apart from the first gasket part by a gap. A connection part is formed to connect between the first gasket part and the second gasket part at the gap and is deformable by an external force.

### CROSS-REFERENCE TO RELATED APPLICATION

This application claims under 35 U.S.C. § 119(a) the benefit of priority to Korean Patent Application No. 10-2019-0067113 filed on Jun. 7, 2019, the entire contents of which are incorporated herein by reference.

### BACKGROUND

### (a) Technical Field

The present disclosure relates to a sealing gasket, and more particularly, to a sealing gasket that effectively cope with a step between joint surfaces in a T-joint part of the assembled parts to prevent sealing quality problems such as oil leakage or water leakage between the parts.

### (b) Background Art

As known, a gasket is widely used for sealing between components to be assembled. To maintain the sealing between components using the gasket, a rubber part of the gasket should be compressed between the parts, and the compressed rubber part should be in close contact with each component by an elastic restoring force to maintain the sealing state. For example, when the oil used for applications such as lubrication, cooling, anticorrosion, or operating fluid of the component of a vehicle needs to circulate or flow along the components, it is sealed by the gasket to prevent the oil from leaking from the gap between the components.

Normally, to maintain the sealing state between two components with the gasket interposed therebetween, the rubber part of the gasket is uniformly pressed by both side components and in close contact with the surface of the component. However, in the T-joint part where three components are assembled instead of two components, it is difficult to maintain the sealing state using one gasket. Examples of assembling the component of the vehicle while forming the T-joint part may be a joint part between a bed plate, an oil pan, and an oil cooler of an engine, a joint part between a cylinder block and a timing chain case, and a joint part between a timing chain case, a timing chain cover, and the oil pan.

As described above, the T-joint part may be generated between the components of the vehicle, particularly, the components of the engine according to the assembling structure. In addition, FIG. 7 is a diagram showing an example in which the components form the T-joint part, and the fluid such as oil or coolant is prevented from being leaked by interposing a gasket 4 between components 1, 2, 3 forming the T-joint part.

Referring to FIG. 7 according to the prior art, the three components 1, 2, 3 form the T-joint part, and the gasket 4 is disposed between the components. However, complete sealing should be performed by the gasket 4 between the components forming the T-joint part, but a step in the T-joint part inevitably occurs due to the dimensional tolerance between the components 1, 2, 3. This step not only deteriorates the sealing performance, but also causes a quality problem such as oil leakage or water leakage.

Accordingly, the components are precisely machined to decrease the tolerance, and the gasket is reinforced to secure the sealing performance, but there is a problem in that the cost excessively increases due to the precision machining. In addition, the gasket reinforcement is limited due to the characteristics of rubber, which is the main material of the gasket, and the conventional gasket also has the structural limitation in solving the quality problem such as oil leakage or water leakage.

The above information disclosed in this section is merely for enhancement of understanding of the background of the disclosure and therefore it can contain information that does not form the prior art that is already known in this country to a person of ordinary skill in the art.

### SUMMARY

Therefore, the present disclosure provides a sealing gasket, which may effectively cope with a step between joint surfaces in a T-joint part of the components to be assembled, thereby preventing a sealing quality problem such as oil leakage or water leakage between the components from occurring, and mitigating the precision machining degree of the T-joint part and the joint surfaces to save the cost.

In order to achieve the object, the present disclosure provides, as a sealing gasket interposed between components when a third component is joined to a first component and a second component, the sealing gasket may include a first gasket part interposed between the first component and the third component; a second gasket part interposed between the second component and the third component and separated and spaced apart from the first gasket part by a gap; and a connection part formed to connect between the first gasket part and the second gasket part at the gap and deformable by an external force.

Herein, the connection part may be cut when an external force of a predetermined level or more is exerted there onto. In addition, a plurality of connection parts disposed at the gap at a predetermined interval may be formed. The first component and the third component may include fluid passages connected to each other in a joint state, and the first gasket part may include a gasket plate interposed between the joint surface of the first component and the joint surface of the third component and having a fluid passage aperture formed therein; and a sealing part of an elastic material installed in the fluid passage aperture to seal between the fluid passage of the first component and the fluid passage of the third component.

The sealing part may be provided in a ring shape to be coupled along the inner diameter portion of the fluid passage aperture of the gasket plate. In addition, the sealing part may be pressed by the joint surface of both sides between the joint surface of the first component and the joint surface of the third component to be compressed and deformed and may be made of a rubber material to be in close contact with the joint surfaces of both sides thereof simultaneously. The sealing part may include protrusions on both surfaces thereof in a shape that extends in both directions with respect to both surfaces of the gasket plate. The protrusion having the ring shape at each surface of the sealing part may be formed in a continuous shape through the entire circumference of the sealing part.

In addition, one or two or more protrusions may be formed on each surface of the sealing part, respectively. Then, the second component and the third component have fluid passages connected to each other in a joint state, and the second gasket part may include a gasket plate interposed between the joint surface of the second component and the joint surface of the third component and having a fluid passage aperture formed therein; and a sealing part of an elastic material installed in the fluid passage aperture to seal between the fluid passage of the second component and the fluid passage of the third component.

In the second gasket part, the sealing part may be provided in the ring shape to be coupled along the inner diameter portion of the fluid passage aperture of the gasket plate. In addition, in the second gasket part, the sealing part may be pressed by the joint surfaces of both sides between the joint surface of the second component and the joint surface of the third component to be compressed and deformed and may be made of a rubber material to be in close contact with the joint surfaces of both sides thereof simultaneously.

In addition, in the second gasket part, the sealing part may include protrusions on both surfaces thereof in a shape extended in both directions with respect to both surfaces of the gasket plate. The protrusion having the ring shape at each surface of the sealing part may be formed in a continuous shape through the entire circumference of the sealing part. One or two or more protrusions may be formed on each surface of the sealing part, respectively.

Therefore, according to the sealing gasket of the present disclosure, it may be possible to be configured to effectively cope with the step between the joint surfaces in the T-joint part of the components to be assembled, thereby preventing the sealing quality problem such as oil leakage or water leakage between the components, and mitigating the precision machining degree of the T-joint part and the joint surface to save the cost.

### BRIEF DESCRIPTION OF THE DRAWINGS

The above and other features of the present disclosure will now be described in detail with reference to exemplary embodiments thereof illustrated the accompanying drawings which are given herein below by way of illustration only, and thus are not limitative of the present disclosure, and wherein:

FIG. 1 is a perspective diagram showing, as a before-assembling state, a sealing gasket according to an exemplary embodiment of the present and components to which a sealing gasket may be applied;

FIG. 2 is a perspective diagram showing the sealing gasket according to an exemplary embodiment of the present disclosure;

FIG. 3 is a cross-sectional diagram showing a state where a sealing part has been assembled in a fluid passage aperture of a gasket plate in the sealing gasket according to an exemplary embodiment of the present disclosure;

FIG. 4 is a cross-sectional diagram showing a state where the sealing is maintained in a state where the sealing part of the sealing gasket according to an exemplary embodiment of the present disclosure has been compressed between the components;

FIGS. 5 and 6 are diagrams showing a method for sealing between the components by using the sealing gasket according to an exemplary embodiment of the present disclosure; and

FIG. 7 is a diagram for explaining a sealing structure of a T-joint part using a conventional sealing gasket according to the prior art.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in section by the particular intended application and use environment. In the drawings, reference numbers refer to the same or equivalent sections of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings so that those skilled in the art to which the present disclosure pertains can easily practice the exemplary embodiments of the present disclosure. However, the present disclosure is not limited to the exemplary embodiments described herein and can also be specified in other forms.

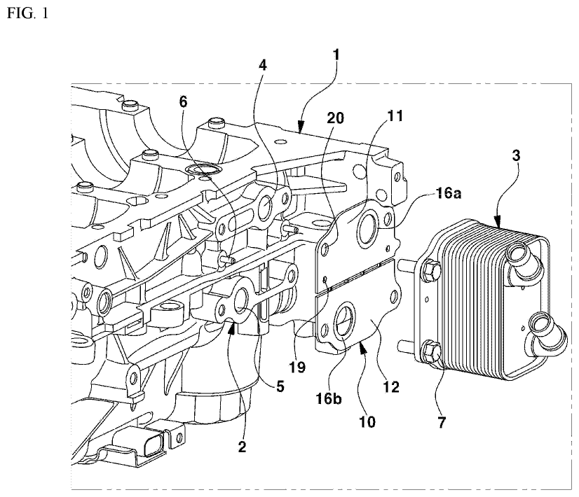

FIG. 1 is a perspective diagram showing a sealing gasket according to an exemplary embodiment of the present disclosure and components to which the sealing gasket may be applied, and shows a state before the components and the sealing gasket are assembled. Referring to FIG. 1, the joint surfaces of the components, joined therebetween when three components 1, 2, 3 may be assembled to be integrated, form a T-joint part, and in addition, a sealing gasket 10 may be disposed between the joint surfaces of the component in the T-joint part of the components 1, 2, 3.

The T-joint part is configured in a structure in which one component of the three components 1, 2, 3 may be joined and coupled to the other two components, and two joined components of both sides all have fluid passages 4, 5, and when the two components of both sides have been joined, the fluid passages 4, 5 of two joined components may be connected to each other to be in a completely sealed state without fluid leakage between the components by the sealing gasket 10 according to the present disclosure.

As described above, the sealing gasket 10 according to the present disclosure may be applied to the T-joint part, and when the three components 1, 2, 3 forming the T-joint part are assembled, the sealing gasket 10 may be interposed between the joint surfaces of the component. In addition, the sealing gasket 10 according to the present disclosure is for sealing between the fluid passages 4, 5 of the components 1, 2, 3 connected so that the fluid may flow when the components 1, 2, 3 have been assembled.

The sealing gasket 10 performs the sealing function that removes the gap between the joint surfaces of the component to prevent fluid from leaking from the fluid passages 4, 5 of the components 1, 2, 3 in the T-joint part. Particularly, the sealing gasket 10 according to the present disclosure may seal the gap between the joint surfaces of the component around the fluid passages 4, 5 connected to each other to prevent leakage of the fluid, even in the T-joint part of the components 1, 2, 3 to be joined.

FIG. 1 shows that the components to which the sealing gasket 10 according to the present disclosure is applied are all engine components while forming the T-joint part, and shows the bed plate 1 on which the passage 4 of an engine oil is prepared, the oil pan 2 for storing engine oil, and the oil cooler 3 for cooling engine oil among the engine components. The bed plate 1, the oil pan 2, and the oil cooler 3 constitute a part of an engine-side oil circuit, and when the oil cooler 3 is assembled to the bed plate 1 and the oil pan 2, it may be assembled in a state where the sealing gasket 10 according to the present disclosure is interposed between the cooler 3 and the bed plate 1, and between the oil cooler 3 and the oil pan 2.

It is for illustrative that the components in FIG. 1 are the bed plate, the oil pan, the oil cooler, and the present disclosure is not limited thereto, and the components requiring fluid sealing between the fluid passages of the component by providing the fluid passage while forming the T-joint part may apply the sealing gasket according to the present disclosure. In an exemplary embodiment of FIG. 1, the fact that the oil cooler 3 forms the T-joint part together with the bed plate 1 and the oil pan 2 simplifies the engine-side oil circuit and to consider the assembled space of the engine components, and the component to which the sealing gasket according to the present disclosure is applied is not limited to the bed plate, the oil pan, and the oil cooler.

It is apparent that FIG. 1 does not show an oil passage (fluid passage) of the oil cooler 3, but the oil passage of the oil cooler in communication with the oil passages (fluid passages) 4, 5 of the bed plate 1 and the oil pan 2. The components 1, 2, 3 shown in FIG. 1 are components forming the T-joint part while having the fluid passages (oil passages) 4, 5, components in which the fluid passages of both sides are connected to each other when joined, and at this time, components in which the gap portion between the fluid passages should be sealed to prevent the fluid leakage, and the sealing gasket 10 according to the present disclosure may be applied to the T-joint part of these components.

In the following description, the bed plate 1 will be referred to as a first component, the oil pan 2 will be referred to as a second component, and the oil cooler 3 will be referred to as a third component. First, the first component 1, the second component 2, and the third component 3 may form the T-joint part, and both the first component 1 and the second component 2 may be assembled to the third component 3. In other words, the first component 1 may be joined and assembled to the third component 3, and the second component 2 may be joined and assembled to the third component 3 separately.

At this time, the joint surface of the third component 3 may be divided into two regions, and in the joint surface of the third component 3, a first region of the two regions may be joined to the joint surface of the first component 1, and a remaining second region of the two regions may be joined to the joint surface of the second component 2. The joint surface of the third component 3 may become a surface having no step between the two regions. In other words, the first region and the second region in the joint surface of the third component 3 form a surface having no step and are only regions divided according to their positions, and the two regions do not have separate different structures on the surface for joining with the counterpart or do not have a step from each other.

In other words, the first region refers to a region where the first component 1 is joined in the joint surface of the third component 3, the second region refers to a region where the second component 2 is joined in the joint surface of the third component 3, and the remaining region except for the first region in the joint surface of the third component 3 may be the second region. Meanwhile, the first component 1 and the second component 2 may be disposed vertically, and assembled to be joined to one component, that is, the third component 3 when the first component 1 and the second component 2 have been disposed vertically.

At this time, the first component 1, the second component 2, and the third component 3 have the fluid passages 4, 5 connected to each other by joining between the components, and the third component 3 may include at least two fluid passages (not shown) connected to the fluid passage 4 of the first component 1 and the fluid passage 5 of the second component 2. In other words, the third component 3 may include at least two fluid passages, and one of the two fluid passages may connected to the fluid passage 4 of the first component 1, and the other one may be connected to the fluid passage 5 of the second component 2.

The sealing gasket 10 according to an exemplary embodiment of the present disclosure may be interposed between the joint surfaces of the component, and more specifically, the sealing gasket 10 may be interposed between the joint surface of the first component (bed plate) 1 and the joint surface of the third component (oil cooler) 3 and between the joint surface of the second component (oil pan) 2 and the third component (oil cooler) 3 to seal the gap between the joint surfaces to prevent the fluid passing through the fluid passages 4, 5 between the joint surfaces of the component from leaking.

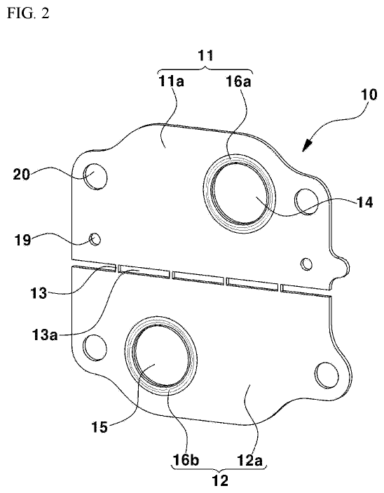

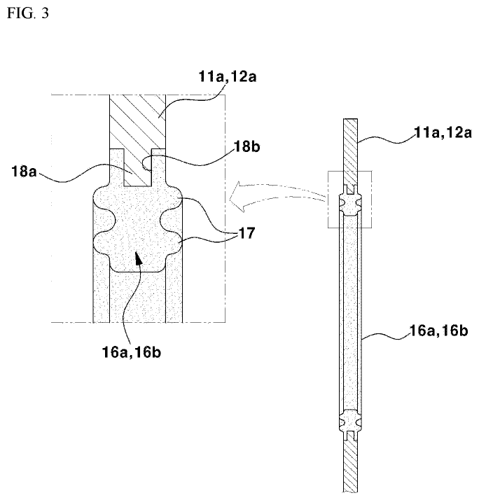

Hereinafter, a sealing gasket according to an exemplary embodiment of the present disclosure will be described in detail with reference to the drawings. FIG. 2 is a perspective diagram showing a sealing gasket according to an exemplary embodiment of the present disclosure, and FIG. 3 is a cross-sectional diagram showing a state where a sealing part has been assembled in a fluid passage aperture of a gasket plate in the sealing gasket according to an exemplary embodiment of the present disclosure.

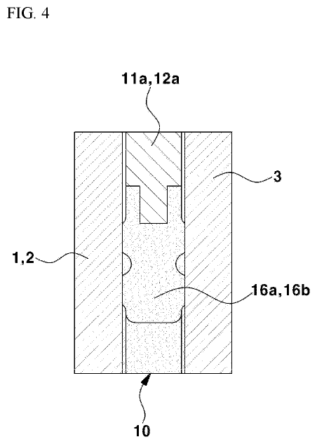

In addition, FIG. 4 is a cross-sectional diagram showing a state where the sealing part of the sealing gasket according to an exemplary embodiment of the present disclosure is maintained in a state compressed between the components. As shown, the sealing gasket 10 may include a first gasket part 11 interposed between the joint surface of the first component 1 and the joint surface of the third component 3, a second gasket part 12 interposed the joint surface of the second component 2 and the joint surface of the third component 3, and a connection part 13 for connecting the first gasket part 11 and the second gasket part 12.

The first gasket part 11 is a gasket part interposed between the joint surface of the first component 1 and the first region of the third component 3, and the second gasket part 12 is a gasket part interposed between the joint surface of the second component 2 and the second region of the third component 3. Both the first gasket part 11 and the second gasket part 12 have a structure in which fluid passage apertures 14, 15 have been formed in gasket plates 11a, 12a, and the fluid passage apertures 14, 15 are installed with sealing parts 16a, 16b of an elastic material.

The gasket plates 11a, 12a form the body of each of the gasket parts 11, 12, may be made of metal, and may be a plate of an aluminum alloy material that is lightweight and satisfies the required strength. In addition, the gasket plate 11a of the first gasket part 11 may be interposed between the joint surfaces of the component to be joined to each other, that is, between the joint surface of the first component 1 and the joint surface of the third component 3, and the gasket plate 12a of the second gasket part 12 may be interposed between the joint surface of the second component 2 and the joint surface of the third component 3.

The gasket plate 11a of the first gasket part 11 may be formed with the fluid passage aperture 14 to be disposed between the fluid passage 4 of the first component 1 and the fluid passage (not shown) of the third component 3 connected thereto. Then, the gasket plate 12a of the second gasket part 12 may be formed with the fluid passage aperture 15 to be disposed between the fluid passage 5 of the second component 2 and the fluid passage (not shown) of the third component 3 connected thereto.

In addition, the fluid passage aperture 14 of the first gasket part 11 and the fluid passage aperture 15 of the second gasket part 12 may be installed with the sealing parts 16a, 16b for sealing to prevent the fluid from leaking between the fluid passages of the component to be joined. The sealing parts 16a, 16b may be ring-shaped members coupled along the inner diameter portions of each of the fluid passage holes 14, 15 in the first gasket part 11 and the second gasket part 12, and may be made of a rubber material that is compressively deformed while being pressed by the components 1, 2, 3 joined to each other.

Explaining with reference to FIG. 3, as shown, the sealing parts 16a, 16b may be coupled along the inner diameter portions of the fluid passage holes 14, 15 formed in each of the gasket plates 11a, 12a, and for this purpose, a fitting part 18a having a shape reduced in thickness compared to the remaining portion of the gasket plate may be formed in the inner diameter portions of the fluid passage apertures 14, 15 in the gasket plates 11a, 12a. The sealing parts 16a, 16b may be installed to be in a state where the fitting part 18a has been fitted into a groove part 18b formed on the outer circumferential surface thereof, and in the mold, the sealing parts 16a, 16b of a rubber material may be vulcanization-molded in the fluid passage apertures 14, 15 to be integrally fixed thereto.

In addition, as shown in FIG. 3, the sealing parts 16a, 16b may include a protrusion 17 of a shape extending in both directions, respectively, with respect to both surfaces of the gasket plates 11a, 12a in the cross section. At this time, the protrusion 17 may be formed in a long continuous shape along the circumferential direction of the sealing parts 16a, 16b, that is, a continuous shape through the entire circumference of the sealing parts 16a, 16b having a ring shape.

The sealing parts 16a, 16b may have one or two or more protrusions 17 arranged in parallel at regular intervals in the radius direction, and one or two or more protrusions 17 thus arranged in parallel may be formed to extend in both directions from both surfaces of the sealing parts 16a, 16b. In the drawing, shown is an exemplary embodiment in which two protrusions, which are disposed in parallel with each surface of the sealing parts 16a, 16b, have been formed. As a result, as shown in FIG. 4, when the sealing gasket 10 according to an exemplary embodiment of the present disclosure is squeezed between the components 1, 2, 3 of both sides thereof to be joined, the protrusions (reference numeral 17 in FIG. 3) of the sealing parts 16a, 16b may be pressed and compressed in both directions by the components of both sides thereof, and after assembled, the sealing may be made between the components when the protrusion of the sealing part has been pressed.

Referring to FIG. 2, shown is a state where the ring-shaped sealing parts 16a, 16b are installed in the fluid passage aperture 14 of the first gasket part 11 and the fluid passage aperture 15 of the second gasket part 12, respectively, and at this time, the first gasket part 11 and the second gasket part 12 separated and spaced at the gap 13a apart from each other have a structure connected to each other by the connection part 13. The connection part 13 connects between the gasket plates 11a, 12a of the gasket parts 11, 12 of both sides thereof, and may be disposed at a predetermined interval by the gap 13a between the gasket parts 11, 12 of both sides thereof.

Each of the connection parts 13 disposed at a predetermined interval has a predetermined width and length, respectively, and in itself becomes a part deformable by an external force. In addition, the connection part 13 may be broken and cut when the external force of a certain level or more acts between the gasket parts 11, 12 of both sides thereof.

As described above, in a state where the first gasket part 11 and the second gasket part 12 have been connected by the connection part 13, the deformation of the connection part 13 acts on absorbing a step held by the joint surfaces of two components 1, 2 joined to the joint surface of the third component 3, that is, the joint surface of the first component 1 and the joint surface of the second component 2.

In the present disclosure, the fact that the gasket parts 11, 12 absorb the step indicates that there is an actual structural and physical step between the joint surfaces of the component 1, 2, 3, but both the gasket parts 11, 12 are in close contact or abutting contact with the respective joint surfaces, thereby overcoming the step and securing the sealing state between the joint surfaces of the component.

The deformation of the connection part 13 appears when the step between the joint surface of the first component 1 and the joint surface of the second component 2 is equal to or less than a certain level, and when the step between the joint surface of the first component 1 and the joint surface of the second component 2 is greater than a certain level, a substantial external force acts on the connection part 13 through the sealing parts 16a, 16b and the gasket plates 11a, 12a upon assembling, such that the connection part may be cut, and the first gasket part 11 and the second gasket part 12 may become a structure at least partially separated from each other due to the cutting of the connection part.

In an exemplary embodiment of the present disclosure, the connection parts 13 may be formed in a structure having a small width and length and are sparsely disposed between the first gasket part 11 and the second gasket part 12 at a predetermined interval, such that the gap 13a between the connection parts 13 and the two gasket parts 11, 12 serves as a perforated line for separating the two gasket parts 11, 12 from each other when an external force of a predetermined level or more acts thereon.

In FIGS. 1 and 2, reference numeral 19 denotes an assembling guide aperture into which a guide pin 6 of the first component 1 may be inserted to join and fix the sealing gasket 10 to the joint surfaces of the components 1, 2 temporarily. In an exemplary embodiment of FIG. 1, the guide pin 6 may be formed in a protruded shape at one side of the joint surface of the first component 1 to which the sealing gasket 10 is squeezed, and at this time, the assembling guide aperture 19 may be penetrated and formed in the first gasket part 11, which is a part squeezed to the joint surface of the first component 1 even in the sealing gasket 10.

In addition, in FIGS. 1 and 2, reference numeral 20 denotes a bolt aperture, and when the third component 3 has been temporarily joined to the first component 1 and the second component 2, as shown in FIG. 1, the third component 3 may be fastened to the first component 1 and the second component 2 using a bolt 7, and at this time, the bolt 7 passes through a bolt aperture 20 of the sealing gasket 10 interposed between the components.

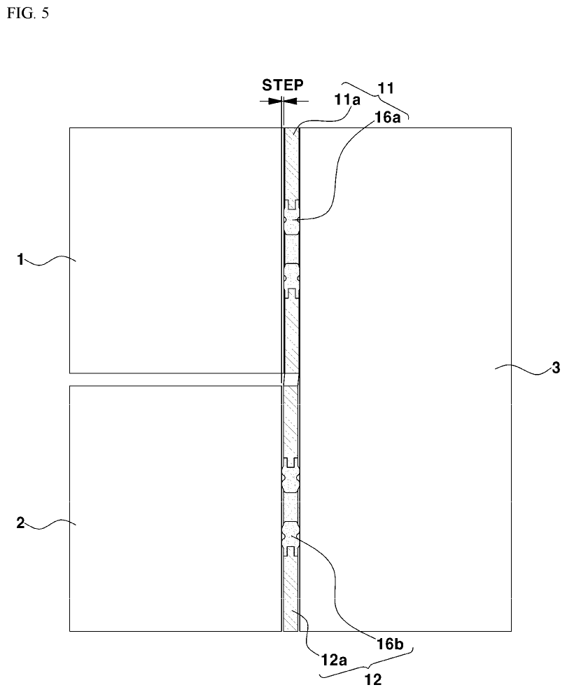

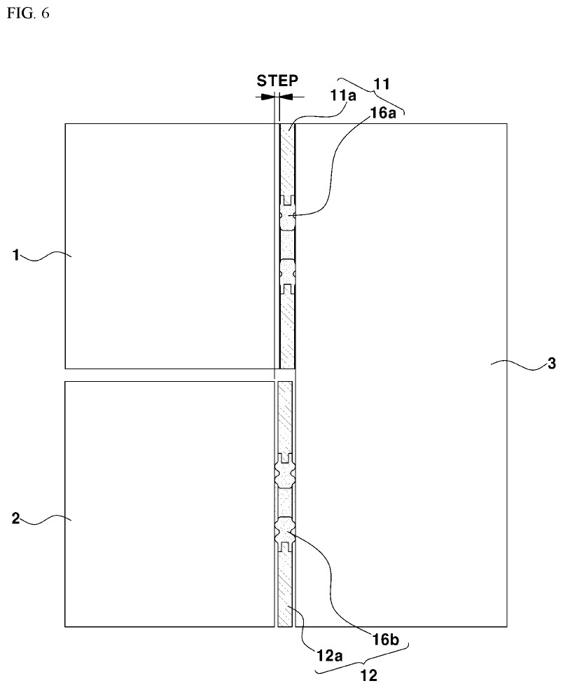

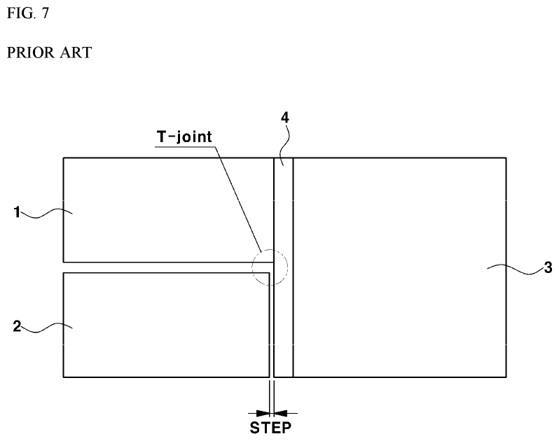

Hereinafter, a sealing method using the sealing gasket and the assembling process of the components will be described. FIGS. 5 and 6 are diagrams for explaining a method for sealing between the components 1, 2, 3 by using the sealing gasket 10 according to an exemplary embodiment of the present disclosure.

The joint surface (sealing surface) of the bed plate (first component) to which the oil cooler (third component) 3 is joined and the joint surface (sealing surface) of the oil pan (second component) 2 manages to reduce possible tolerances through precision machining. However, a step may be present between the surfaces of the two components 1, 2 joined to the surface of the oil cooler (third component) 3, that is, the joint surface of the bed plate as the first component 1 and the joint surface of the oil cooler as the second component 2. The step between the joint surface of the first component 1 and the joint surface of the second component 2 may be increased and reduced according to the tolerance state and the machining state, etc. of the joint surface.

FIG. 5 is a diagram showing an example in which the step between the joint surfaces of the first component 1 and the second component 2 is minimal, and one sealing gasket 10 may be disposed between the first component 1, the second component 2, and the third component 3, and then the components 1, 2, 3 may be joined and then fastened and fixed to be in a pressed state.

At this time, if the third component 3 is an oil cooler, as shown in FIG. 1, the oil cooler may be fastened to the bed plate as the first component 1 and the oil pan as the second component 2 using the bolt 7 and thus, the sealing gasket 10 may be squeezed between the components when fastened by the bolt. Of course, as described above, the guide pin 6 of the bed plate 1 (or the oil pan) may be fitted into the assembling guide aperture 19 of the sealing gasket 10 to first secure the assembling position of the sealing gasket 10, and then the oil cooler 3 abuts the sealing gasket 10.

When the bolt is fastened in a state where the oil cooler 3 has been in close contact with the sealing gasket 10, the oil cooler may press the sealing part 16a of the first gasket part 11, and therefore, the sealing part 16a of the first gasket part 11 may be pressed at both sides by the joint surface of the bed plate 1 and the joint surface of the oil cooler 3 to be compressed as in FIG. 4. Likewise, the oil cooler 3 may press the sealing part 16b of the second gasket part 12, and therefore, the sealing part 16b of the second gasket part 12 may be pressed at both sides by the joint surface of the oil pan 2 and the joint surface of the oil cooler 3 to be compressed as in FIG. 4.

As described above, the fact that the sealing parts 16a, 16b are pressed and compressed is that the protrusion 17 of the sealing part may be pressed and compressed by the joint surfaces of the components 1, 2, 3, and in this state, the sealing state between the components may be maintained by the sealing parts 16a, 16b compressed between the components when the bolt fastening of the components is completed.

In an example of FIG. 5, the gasket plate 11a of the first gasket part 11 may be aligned and disposed at the center between the joint surfaces of the two components 1, 3, when the protrusions 17 of both sides of the sealing part 16a are simultaneously pressed at both sides by the bed plate 1 and the oil cooler 3. Likewise, the gasket plate 12a of the second gasket part 12 may be aligned and disposed at the center between the joint surfaces of the two components 2, 3, when the protrusions 17 of both sides of the sealing part 16b are simultaneously pressed at both sides by the oil pan 2 and the oil cooler 3.

In other words, the first gasket part 11 may be compressed while the sealing part 16a and the protrusion 17 are simultaneously pressed by the joint surfaces of both sides between the joint surface of the bed plate 1 and the joint surface of the oil cooler 3, and at this time, the gasket plate 11a of the first gasket part 11 may be aligned and disposed at the center between the joint surface of the bed plate 1 and the joint surface of the oil cooler 3. Then, the second gasket part 12 may also be compressed while the sealing part 16b and the protrusion 17 may be simultaneously pressed by the joint surfaces of both sides between the joint surface of the oil pan 2 and the joint surface of the oil cooler 3, and at this time, the gasket plate 12a of the second gasket part 12 may also be aligned and disposed at the center between the joint surface of the oil pan 2 and the joint surface of the oil cooler 3.

In addition, as in FIG. 5, when the step between the components 1, 2 is relatively small, the gasket plate 12a of the second gasket part 12 may be deviated within a relatively small range with respect to the gasket plate 11a of the first gasket part 11, and the relative position of the gasket plate 12a of the second gasket part 12 to the gasket plate 11a of the first gasket part 11 may be placed within a deformation range without breakage or cutting of the connection part 13.

As described above, the gasket plate 11a of the first gasket part 11 and the gasket plate 12a of the second gasket part 12 may be disposed at the positions differently from each other, but the gasket plates 11a, 12a of the two gasket parts 11, 12 move to the intermediate position between the two components and only the deformation of the connection part 13 occurs, and at this time, the relative movement of the gasket plates 11a, 12a occurs within a small range in which the deformation of the connection part 13 occurs. As described above, the position of the two gasket plates 11a, 12a may be adjusted simultaneously with the deformation of the connection part 13 in the assembling process, and thus, the sealing gasket 10 may absorb the step between the components 1, 2.

FIG. 6 is a diagram showing a case where the step between the joint surfaces of the two components 1, 2 is greater than that in the example of FIG. 5, and shows a state where a substantial step of a certain level or more has occurred between the joint surface of the first component 1 and the joint surface of the second component 2. In an example of FIG. 6, when the third component 3 has contacted the first gasket part 11 in the assembling process, the gap between the third component 3 and the second component 2 is greater than the gap between the third component 3 and the first component 1.

Therefore, when the third component 3 simultaneously presses the first gasket part 11 and the second gasket part 12 for fastening and assembling with the counterparts 1, 2, the gasket plate 11a of the first gasket part 11 and the gasket plate 12a of the second gasket part 12 are minimal but moves toward the first component 1 and the second component 2, while the protrusions 17 of the sealing parts 16a, 16b are compressed on the two gasket parts 11, 12, and at this time, since the amount of movement of the gasket plate 12a of the second gasket part 12 is greater than the amount of movement of the gasket plate 11a of the first gasket part 11, the cutting of the connection part 13 may occur.

As described above, in an example of FIG. 6, the connection part may be cut beyond the deformation level of the connection part 13 to become the form in which the first gasket part 11 and the second gasket part 12 are separated along the perforated line, and as a result, it may be possible to exert the effect of assembling two gaskets separately between the first component 1 and the third component 3, and between the second component 2 and the third component 3. At this time, the second gasket part 12 having a larger step may be naturally moved by pressing between the components 1, 3 to exert the effect of absorbing the step, and therefore, the sealing between the components becomes more reliable than the conventional one.

As described above, although the exemplary embodiments of the present disclosure have been described in detail, the claims of the present disclosure is not limited to the above-described exemplary embodiments, and various modifications and improvements by those skilled in the art using the basic concept of the present disclosure defined in the appended claims can also be included the claims of the present disclosure.

What is claimed is:

1. A sealing gasket, comprising:
a third component joined to a first component and a second component, wherein the sealing gasket is interposed between the first component, second component, and third component,
a first gasket part interposed between the first component and the third component;
a second gasket part interposed between the second component and the third component and separated and spaced apart from the first gasket part by a gap; and
a connection part formed to connect between the first gasket part and the second gasket part at the gap and deformable by an external force.

2. The sealing gasket of claim 1, wherein the connection part is provided to be cut when an external force of a predetermined level or more acts there onto.

3. The sealing gasket of claim 1, wherein a plurality of connection parts are disposed at the gap at a predetermined interval.

4. The sealing gasket of claim 1, wherein the first component and the third component have fluid passages connected to each other in a joint state, and wherein the first gasket part includes:
a gasket plate interposed between the joint surface of the first component and the joint surface of the third component and having a fluid passage aperture formed therein; and
a sealing part of an elastic material installed in the fluid passage aperture to seal between the fluid passage of the first component and the fluid passage of the third component.

5. The sealing gasket of claim 4, wherein the sealing part is provided in a ring shape to be coupled along the inner diameter portion of the fluid passage aperture of the gasket plate.

6. The sealing gasket of claim 5, wherein the sealing part is pressed by the joint surface of both sides between the joint surface of the first component and the joint surface of the third component to be compressed and deformed and is made of a rubber material to abut the joint surfaces of both sides thereof simultaneously.

7. The sealing gasket of claim 5, wherein the sealing part has protrusions on both surfaces thereof in a shape extending in both directions with respect to both surfaces of the gasket plate.

8. The sealing gasket of claim 7, wherein the protrusion having the ring shape at each surface of the sealing part is formed in a continuous shape through the entire circumference of the sealing part.

9. The sealing gasket of claim 8, wherein one or two or more protrusions are formed on each surface of the sealing part, respectively.

10. The sealing gasket of claim 5, wherein the second component and the third component have fluid passages connected to each other in a joint state, and wherein the second gasket part includes:
a gasket plate interposed between the joint surface of the second component and the joint surface of the third component and having a fluid passage aperture formed therein; and
a sealing part of an elastic material installed in the fluid passage aperture to seal between the fluid passage of the second component and the fluid passage of the third component.

11. The sealing gasket of claim 10, wherein in the second gasket part, the sealing part is provided in the ring shape to be coupled along the inner diameter portion of the fluid passage aperture of the gasket plate.

12. The sealing gasket of claim 11, wherein in the second gasket part, the sealing part is pressed by the joint surfaces of both sides between the joint surface of the second component and the joint surface of the third component to be compressed and deformed and is made of a rubber material to abut the joint surfaces of both sides thereof simultaneously.

13. The sealing gasket of claim 11, wherein in the second gasket part, the sealing part has protrusions on both surfaces thereof in a shape extending in both directions with respect to both surfaces of the gasket plate.

14. The sealing gasket of claim 13, wherein in the second gasket part, the protrusion having the ring shape at each surface of the sealing part is formed in a continuous shape through the entire circumference of the sealing part.

15. The sealing gasket of claim 14, wherein in the second gasket part, one or two or more protrusions are formed on each surface of the sealing part, respectively.
